(19) United States
(12) Patent Application Publication
(10) Pub. No.: US 2011/0043476 A1
(43) Pub. Date: Feb. 24, 2011

(54) Scrollbar and Touchpad with Tactile and/or Audible Feedback

(75) Inventors: Martin Wraber Christensen, Copenhagen (DK); Joakim Korner Nielsen, Aalborg (DK); Christine Broe, Aalborg (DK); Esa Petteri Nousiainen, Vantaa (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/377,812

(22) PCT Filed: Aug. 17, 2006
(86) PCT No.: PCT/EP2006/008110

§ 371 Date: Nov. 9, 2010

(51) Int. Cl. G06F 3/044; G06F 3/041

(52) U.S. Cl. 345/174; 345/173

(57) ABSTRACT

A scrollbar or touchpad including a touch area and disposed on a flexible layer that is supported by a rigid substrate. The bottom surface of the flexible layer and the top surface of the substrate, eventually in combination with elements disposed therebetween are configured to provide a pattern of varying resistance to depression of the flexible layer. A user will feel the varying resistance to depression when moving a fingertip over the touch sensitive surface, thereby receiving tactile feedback. The elements disposed between the bottom surface of the flexible layer and the top surface of the substrate can be collapsible members such as collapsible domes or switches that produce a “click” sound when collapsing, thus providing both tactile and audible feedback to the user.

### FIELD OF THE INVENTION

The present invention relates to navigational input devices for employment in a user interface of electronic devices, especially scrollbars and touchpads.

### BACKGROUND OF THE INVENTION

Scrollbars and touchpads are useful input elements for mobile electronic devices that have ergonomic advantages over other input devices such as navigation keys and joysticks. One of the advantages is that the user can determine the speed at which he/she slides their fingertip over the scrollbar completely at their own discretion, and the fact that the scrollbar allows for a continuous smooth input. Another advantage is the ease with which scrollbars can be integrated in a surface of the electronic devices.

A disadvantage of capacitive touch type scrollbars and touchpads is the lack of feedback to the user. For example when the scrollbar is used to scroll through a list of discrete items that is shown on the display of the electronic device the user does not get any feedback how much movement along the scrollbar will result in another step in the scrolling procedure.

### DISCLOSURE OF THE INVENTION

On this background, it is an object of the present invention to provide a scrollbar for use as a user interface element in an electronic device that is capable of providing tactile and/or audible feedback to the user. This object is achieved by providing an input device for a user interface of an electronic device comprising a touch sensitive surface disposed on the top side of a flexible layer of material, a substantially rigid substrate supporting the layer of flexible material, whereby the bottom side of the flexible layer of material and the top side of the substrate are, eventually in combination with elements disposed therebetween, configured to provide a pattern of varying resistance to depression of the flexible layer that can be sensed by a user sliding a fingertip or object with some pressure over the touch sensitive surface.

By providing a pattern of varying resistance to depression the user is able to feel when a given predetermined distance of movement along the touch sensitive surface has been reached. This provides the user with a tactile feedback that improves user confidence and accuracy of input.

The elements are disposed between the flexible layer and the substrate can be collapsible elements. When passing with a fingertip over the area of the touch sensitive area above the collapsible element, the user will receive tactile feedback caused by the sudden reduction in resistance to depression when the collapsible element collapses.

Preferably, the collapsible elements are configured to produce a sound when they collapse that can be detected by a user, thereby providing the audible feedback.

The collapsible elements can be collapsible domes.

The collapsible elements may include electric switches.

The electric switches can be resilient switches.

The touch surface can be a sensitive surface capable of detecting touch. Preferably, the touch sensitive surface is a capacitive touch sensitive surface.

The bottom side of the flexible layer of material and/or the top side of the substrate can be provided with a pattern of protrusion and/or recesses for creating the pattern of varying resistance to depression of the flexible layer.

Preferably, the pattern includes regularly spaced areas, lines or points at which the flexible layer has a higher resistance to being depressed with area, lines or points therebetween at which the flexible layer has a lower resistance to being depressed.

The areas, lines or points may be regularly or substantially equally spaced apart.

The touch sensitive area can have suitable dimensions for use as a touchpad. Alternatively, the touch sensitive area may have an elongated shape rendering the input device suitable for use as a scroll bar.

It is another object to provide an electronic communication device including an input device according to the present invention.

The electronic device may comprise a processor coupled to the input device, wherein the processor is configured to accept a detected movement of an object over the touch sensitive area with a minimum given distance in a given direction and passing over one of said areas, lines or points of high resistance to depression as at least one discrete input unit for at least one of the functionalities of the device.

The electronic device may comprise a processor coupled to the input device, wherein the processor is configured to accept a detected movement of an object over the touch sensitive area with a minimum given distance in a given direction and passing over one of the areas, lines or points of low resistance to depression as at least one discrete input unit for at least one of the functionalities of the device.

The electronic device may comprise a processor coupled to the input device, wherein the processor is configured to accept a detected movement of an object over the touch sensitive area with a minimum given distance in a given direction and passing over one of the collapsible elements as at least one discrete input unit for at least one of the functionalities of the device.

The processor of the electronic device may be configured to increase the number of discrete input units associated with the passing over one area, line, point or collapsible element with increasing detected velocity of the object moving over the touch sensitive surface.

The functionality excepting the discrete input units can be the scrolling of an array on a display of the device. The array can be a list.

It is another object of the present invention to provide a method for creating feedback in a navigational input device that is provided with a touch surface. This object is achieved by a providing a method comprising: providing a flexible touch surface over which a user can move a fingertip or an object for creating navigational input, and providing a pattern of varying resistance to depression of the flexible touch surface that can be sensed by a user sliding a fingertip or object with some pressure over the touch sensitive surface.

It is yet another object of the present invention, to provide a method for entering navigational input into a mobile electronic device. This object is achieved by providing a method a comprising providing a flexible touch surface over which a user can move a fingertip or an object for creating navigational input, providing an array of switches disposed below said flexible touch surface, and accepting navigational input when said resilient switches are activated by pressure applied through the flexible touch surface.

Further objects, features, advantages and properties of the input device and electronic device according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a front view of a mobile terminal with a scrollbar according to an embodiment of the invention,

FIG. 2 is a block diagram illustrating the general architecture of the mobile phone of FIG. 1,

FIG. 3 is an exploded view in detail of a portion of the keypad including the scroll bar of the mobile phone shown in FIG. 1,

FIG. 4 is a sectional view through the keymat, scroll bar and printed circuit board shown in FIG. 1, and

FIG. 5 is a sectional view through a keymat, scroll bar and printed circuit board according to another embodiment of the invention.

### DETAILED DESCRIPTION OF PREFERRED EMBODIMENTS

In the following detailed description, the input device and the mobile terminal according to the invention in the form of a cellular/mobile phone will be described by the preferred embodiments.

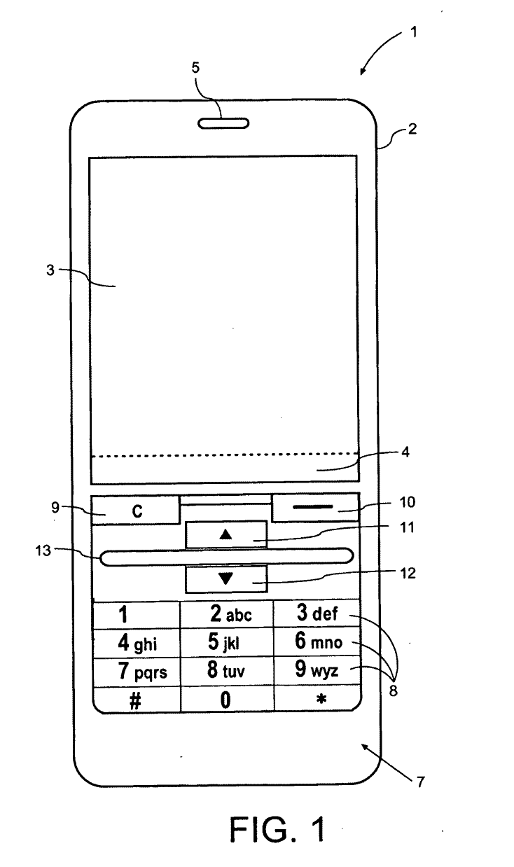

FIG. 1 illustrates a first embodiment of a mobile terminal that is provided with a scroll bar according to the invention in the form of a mobile telephone 1 by a front view and a side view, respectively. The mobile phone 1 comprises a user interface having a housing 2, a display 3, an on/off button (not shown), a speaker 5 (only the opening is shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 2 has additionally a second group of keys comprising a clear key 9, a softkey 10, a scroll/navigating key 11 for scrolling/navigating up and a scroll/navigating key 12 for scrolling/navigating down, a scroll bar 13 for scrolling/navigating left and right. The surface of the scroll bar can be formed by an array of capacitive touch sensors (not shown). The function of the softkey 10 is shown as a soft label in a dedicated area 4 for the display 3 just above the softkey 10 and depends on the state of the mobile phone 1, and navigation in the menu is performed by using the scroll keys 11,12 and the scroll bar 10,11.

The softkey 10 is used for selecting the function indicated in the area 4 whilst the clear key 9 is used for stepping back in the menu structure, clearing characters and call rejection. The functions indicated in the area 4 include call handling functions such as initiating a call, terminating a call and any other functions that can be performed by a mobile phone.

A releasable rear cover (not shown) gives access to the SIM card 20 (FIG. 4), and the battery pack 24 (FIG. 4) in the back of the phone that supplies electrical power for the electronic components of the mobile phone 1.

The mobile phone 1 has a flat display 3 that is typically made of an LCD with optional back lighting, such as a TFT matrix capable of displaying color images. A touch screen may be used instead of a conventional LCD display.

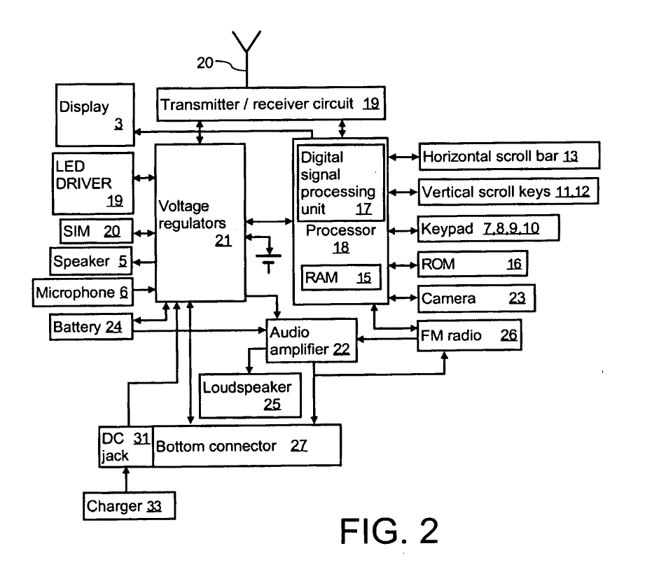

FIG. 2 illustrates in block diagram form the general architecture of a mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 19 (for the LEDS backlighting the keypad 7 and the display 3), the SIM card 20, battery 24, the bottom connector 27, the DC jack 31 (for connecting to the charger 33) and the audio amplifier 32 that drives the (hands-free) loudspeaker 25.

The processor 18 also forms the interface for some of the peripheral units of the device, including a Flash ROM memory 16, the graphical display 3, the keypad 7, the navigation up key 11, the navigation down key 12, the horizontal scroll bar 13, a camera 23 and an FM radio 26.

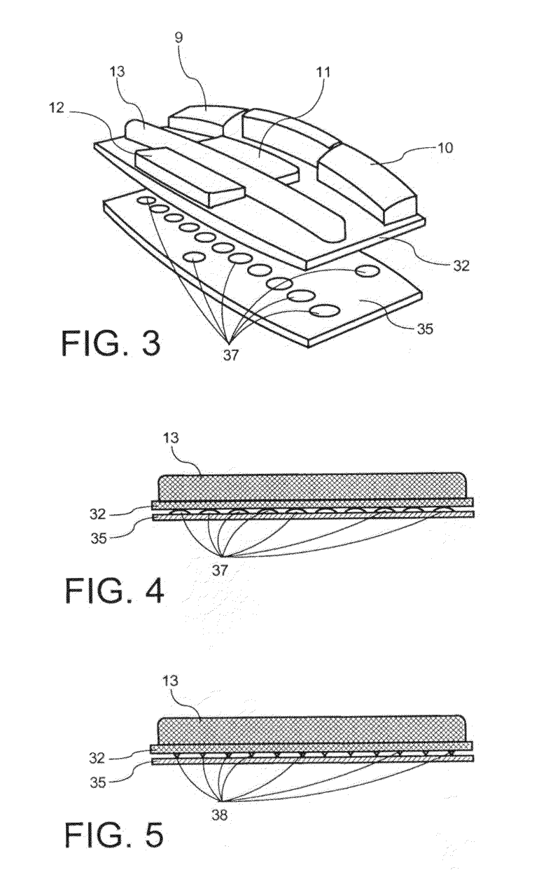

FIGS. 3 and 4 illustrate the horizontal scroll bar in greater detail by an exploded elevated view and a sectional view, respectively.

The scroll bar 13 includes an elongated bar of a flexible material, such as rubber (natural, synthetic or mixtures thereof). The top surface bar of flexible material is provided with a touch sensitive surface (not separately shown), which is connected to the processor 18. The bar is disposed on a keymat 32 that is made from a similar flexible material as the bar. The other keys 9, 10, 11, 12 are also attached to the keymat 32. The keymat 32 forms a layer of flexible material ensuring that the keys are correctly spaced. The keymat 32 is placed under the outer cover over the mobile phone 1 with the keys 9,10,11,12 and the scroll bar 13 received in matching openings (not shown) in the cover. The top surfaces of the keys 9,10,11,12 protrude from the cover or are at least flush therewith. The scroll 13 bar protrudes from the cover.

The keymat 32 is supported by the printed circuit board 35 that is fixed to the frame (not shown) of the mobile phone 1. Collapsible domes 37 are provided on the upper surface of the printed circuit board 35. A row of eleven equally spaced collapsible domes 37 is placed right under the scroll bar 13 (any other number of collapsible domes could be used). One collapsible dome 37 is disposed under each of the other keys of the keypad 8. The collapsible domes 37 that are provided under the various keys (not those under the scroll bar) are configured as electronic switches and connected via the printed circuit board 35 to the processor 18.

According to a variation of the present embodiment (same Figs. apply), the scroll bar 13 is not provided with a touch sensitive surface, but instead the collapsible domes 37 are dome switches. The dome switches are connected to the processor 18 via the printed circuit board 35. In this embodiment the processor 18 receives the user input via activation of the respective dome switches 37. Instead of dome switches other types of resilient switches can be used.

In operation the user moves his/her fingertip over the scroll bar 13 with a given amount of pressure, thereby depressing the flexible scrollbar to an extent that depends on the support provided by the structure under the scroll bar 13. In the present embodiment, the collapsible domes 37 provide for the varying resistance to depression that suddenly changes when a collapsible dome 37 below the fingertip collapses and suddenly reduces the support provided by the structure under the scroll bar 13. Thus, when the user moves his/her finger over the scroll bar, he/she will receive tactile feedback in the form of a sudden change in resistance to depression that can be sensed through the fingertips. Further, a collapsible dome 37 will produce a “click” like sound when it collapses, thereby providing the user with an audible feedback.

According to an embodiment of the invention, the processor 18 is configured to accept a sliding movement (as detected by the touch sensitive surface of the scroll bar) over the scroll bar 13 from a position at one side of a collapsible dome to a position on top of, or on another side of a collapsible dome 37 (i.e. over a collapsible dome) as one input unit for a particular function or application of the mobile phone 1. Such a function or application could be the scrolling of a list on the display 3. Such a list could be a list of contacts or a list of menu items. Thus, when the user moves his/her fingertip over one of the collapsible domes 37, the perceived audible and/or tactile feedback will substantially coincide with one scrolling step of the list on the display. This will facilitate control over the speed of scrolling when the user moves his/her fingertip over the length of the scrolling bar, since each perceived “click” caused by a collapsing dome 37 will correspond to one step in the scrolling activity. It will be understood that the input unit could be used for any other application that requires navigational user input, and is therefore not limited to the scrolling of lists or arrays.

For certain applications it could be an advantage that the speed at which the user moves his/her finger over the scrolling bar is taken into account, whereby a low speed will have one input unit assigned to each collapsible dome 37 that is passed, and higher speeds will incrementally cause a higher number of input units to be assigned to each collapsible dome 37 that is passed.

FIG. 5 illustrates another embodiment of the scroll bar according to the invention. This embodiment is essentially identical with the embodiment described above, however the collapsible domes have been replaced with equally spaced narrow ridges 38 protruding from the bottom surface of the keymat 32 and distributed along the length of the scroll bar 13. The ridges 38 do not collapse, however, they provide for a pattern of locally increased resistance to depression of the scroll bar 13. Thus, when the user moves his/her fingertip over the scroll bar, he/she will sense a varying resistance to depression of the scroll bar 13. Thereby, the user will receive a tactile feedback, which is preferably synchronized with the acceptance of one or more input units by the processor 18. The ridges 38 may extend across the full width of the scroll bar. However, the ridges may alternatively be shorter or not even have a real length, so that they become cones.

In a variation of the present embodiment (not shown), the ridges 38 are parts that protrude from the printed circuit board 35, and the bottom surface of the keymat 35 is substantially even. In another variation (not shown) of the present embodiment the difference in the resistance to depression is created by recesses formed in the top surface of the printed circuit board and/or the bottom surface of the keymat 32. In yet another variation of the present embodiment (not shown), the bottom surface of the keymat 32 and the top surface of the printed circuit board are substantially even, and the ridges 38 are formed by a separate mat that is disposed between the keymat 32 and the printed circuit board 35.

In yet another embodiment of the invention (not shown) the input device is a touchpad. In this embodiment a plurality of parallel rows of collapsible domes is provided on the printed circuit board. Alternatively, there are no collapsible domes but instead an array or other suitable pattern of ridges, cones or similar elements between the keymat and the printed circuit board. An example of such a suitable pattern is a plurality of concentric circles with stepped difference in diameter. Another example of such a suitable pattern is a rectangular grid.

In all the embodiments above it is possible to use an object held by a user, such as a stylus, that is brought into contact/moved over the touch surface of the scroll bar or touchpad.

The term “comprising” as used in the claims does not exclude other elements or steps. The term “a” or “an” as used in the claims does not exclude a plurality. The single processor or other unit may fulfill the functions of several means recited in the claims.

The reference signs used in the claims shall not be construed as limiting the scope.

Although the present invention has been described in detail for purpose of illustration, it is understood that such detail is solely for that purpose, and variations can be made therein by those skilled in the art without departing from the scope of the invention.

1. An input device for a user interface of an electronic device comprising:
a touch surface disposed on the top side of a flexible layer of material,
a substantially rigid substrate supporting the layer of flexible material,
whereby the bottom side of the flexible layer of material and the top side of the substrate are, eventually in combination with elements disposed therebetween, configured to provide a pattern of varying resistance to depression of the flexible layer that can be sensed by a user sliding a fingertip or object with some pressure over the touch sensitive surface.

2. An input device according to claim 1, wherein elements are disposed between the flexible layer and the substrate comprise collapsible elements.

3. An input device according to claim 2, wherein the collapsible elements are configured to produce a sound when they collapse that can be detected by a user.

4. An input device according to claim 2 or 3, wherein the collapsible elements are collapsible domes.

5. An input device according to any of claims 2 to 4, wherein the collapsible elements include electric switches.

6. An input device according to claim 5, wherein electric switches are resilient switches.

7. An input device according to any of claims 1 to 4, wherein said touch surface is a sensitive surface capable of detecting touch.

8. An input device according to claim 7, wherein the touch sensitive surface is a capacitive touch sensitive surface.

9. An input device according to any of claims 1 to 8, wherein the bottom side of the flexible layer of material and/or the top side of the substrate is provided with a pattern of protrusion and/or recesses.

10. An input device according to any of claims 1 to 9, wherein the pattern includes regularly spaced areas, lines or points at which the flexible layer has a higher resistance to being depressed with area, lines or points therebetween at which the flexible layer has a lower resistance to being depressed.

11. An input device according to claim 10, wherein said areas, lines or points are regularly or substantially equally spaced apart.

12. An input device according to any of claims 1 to 11, wherein the touch sensitive area has suitable dimensions for use as a touchpad.

13. An input device according to any of claims 1 to 11, wherein the touch sensitive area has an elongated shape rendering the input device suitable for use as a scroll bar.

14. An electronic communication device including an input device according to any of claims 1 to 13.

15. An electronic device according to claim 14 comprising a processor coupled to said input device, wherein said processor is configured to accept a detected movement of an object over the touch sensitive area with a minimum given distance in a given direction and passing over one of said areas, lines or points of high resistance to depression as at least one discrete input unit for at least one of the functionalities of the device.

16. An electronic device according to claim 15 comprising a processor coupled to said input device, wherein said processor is configured to accept a detected movement of an object over the touch sensitive area with a minimum given distance in a given direction and passing over one of said areas, lines or points of low resistance to depression as at least one discrete input unit for at least one of the functionalities of the device.

17. An electronic device according to claim 16 comprising a processor coupled to said input device, wherein said processor is configured to accept a detected movement of an object over the touch sensitive area with a minimum given distance in a given direction and passing over one of said collapsible elements as at least one discrete input unit for at least one of the functionalities of the device.

18. An electronic device according to any of claims 17 to 13, wherein the processor is configured to increase the number of discrete input units associated with the passing over one area, line, point or collapsible element with increasing detected velocity of the object moving over the touch sensitive surface.

19. An electronic device according to any of claims 18 to 14, wherein said functionality is the scrolling of an array on a display of the device.

20. An electronic device according to any of claims 19 to 15, wherein the array is a list.

21. A method for creating feedback in a navigational input device that is provided with a touch surface, comprising:
providing a flexible touch surface over which a user can move a fingertip or an object for creating navigational input, and
providing a pattern of varying resistance to depression of the flexible touch surface that can be sensed by a user sliding a fingertip or object with some pressure over the touch sensitive surface.

22. A method for entering navigational input into a mobile electronic device, comprising:
providing a flexible touch surface over which a user can move a fingertip or an object for creating navigational input,
providing an array of switches disposed below said flexible touch surface, and
accepting navigational input when said resilient switches are activated by pressure applied through the flexible touch surface.
